(19) United States
(12) Patent Application Publication
(10) Pub. No.: US 2009/0204880 A1
(43) Pub. Date: Aug. 13, 2009

(54) METHOD OF STORY TELLING PRESENTATION AND MANUFACTURING MULTIMEDIA FILE USING COMPUTER, AND COMPUTER INPUT DEVICE AND COMPUTER SYSTEM FOR THE SAME

(76) Inventor: Yun Yong Ko, Gwangju (KR)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/304,182

(22) PCT Filed: Oct. 11, 2007
(86) PCT No.: PCT/KR2007/004969

§ 371 Date: Dec. 10, 2008

(30) Foreign Application Priority Data
Oct. 25, 2006 (KR) 1020060104106

(51) Int. Cl. G06F 17/00; G06F 3/048

(52) U.S. Cl. 715/202; 715/764; 715/810

(57) ABSTRACT

The present invention provides a method of story telling presentation, and a computer input device and a computer system for the same. The method of story telling presentation according to the present invention includes embedding multimedia objects including a plurality of images relevant to a specific story, a subject forming a story or a specific subject into an execution file, a system or a server using an usual computer and dumping the multimedia objects on a screen of the computer; and selecting one of the dumped objects and arranging the one of the dumped objects at a certain position on a canvas or stage of a middle portion of the screen or a background screen. According to the present invention, a user can easily manufactures an image or animation suitable for a multimedia presentation at first hand. Further, because a simple change or animation effect, such as showing and moving an actor in accord with situations of a lecture or discourse, can be given in realtime, an animated presentation can be realized.

### TECHNICAL FIELD

The present invention relates to a multimedia presentation method that, on a display connected to a computer, a presentation such as lecture, explanation, play, role play and storytelling can be performed while materials such as image, animation and text are arranged, moved and changed in realtime, and an computer input device and a computer system for the same.

### BACKGROUND ART

Generally, students can easily understand during a lecture when audio-visual materials are appropriately used. Accordingly, to raise educational performance, it is desirable to perform a lecture while educational materials such as image, animation and moving image are shown according to sequence of a lecture or story

In the prior art, to get this educational performance, a method to explain while pictures are drawn or texts are written on a blackboard, a method to explain while pictures or texts of cards are shown one by one, a method to explain while pictures, tables, texts and like of a wall map are turned over one by one, a method to perform a doll play or a play, and the like have been used.

However, because, for these methods, preparation of materials is very vexatious and only relatively simple materials should be used, there is a problem that a lecturer should explain in detail.

Further, when a cotton flannel board is used, it is easy to discourse while pictures are attached one by one on the cotton flannel board. However, there is a problem that it is difficult to manage items used.

Because of these problems, a method to slide-show pictures one by one using a television or computer, show an animation or movie, or show texts and images edited using a computer page by page have recently been used much.

However, even though an animation or movie has a relatively high completion and draws interest, there are problems that it is watched passively by students and it is not easy for a lecturer to explain additionally in mid course. A doll play or play has similar problems.

Further, because watching a dynamic animation or movie has reality more than watching a static image, educational performance is high. However, there is a disadvantage that it costs higher. There is a problem that an animation or movie nearly does not have educational usefulness except for usage of one-sidely showing it to learners in that there is no room of change.

Accordingly, it is desirable that a leturer manufactures at first hand and use an image or animation suitable for a lecture or explanation, but it is not easy to manufacture the image and animation.

For example, to manufacture images needed on computer, running a program first, then searching and fetching a background image, then searching and fetching an image attached to the background, then adjusting size and direction of the image and then copying the image to a clipboard should be performed.

Subsequently, activating the background image, then attaching the image, adjusting and fixing a position of the image and then saving a whole picture as one image file should be performed.

However, it takes much time and many processes to search a background image and an image to attach in the prior art graphic program, and a separate graphic viewer program should be used mostly to search an image.

Further, size adjustment, direction change, copy and attachment of an image take many processes, and because of these complicated processes, manufacturing or editing an image at first hand on an educational field is evaded.

Particularly, because image manufacturing processes are complicated in the prior art graphic tool, the graphic tool is used only for image manufacturing and is difficult to use as a multimedia presentation tool changing an image in realtime according to contents of a lecture.

In the mean time, to take an suitable image needed for a lecture, a lecturer should take a picture with a digital camera, scan a picture, draw a picture using a graphic tool, or purchase a clipart on the market.

However, in a case of taking a picture, it is difficult to take a desired image and it is inevitable to make an acting somewhat. For scanning, there is a problem that a picture needed should be drawn first.

Further, in a case of draw a picture using a graphic tool, much skill, time and idea are required, and, in a case of using a clipart on the market, it is not easy to take a desired image and there is an inconvenience of editing with various characters and items.

In the mean time, an interactive or two-way game such as a baduk, janggi and board, which more than one person can enjoy together, has widely spread recently. Accordingly, need for a computer system, where more than one pointing device are connected to one computer and each pointing device independently operates a separate pointer, has increased.

Further, the need for this pointing device has increase not only in a game field but also in a field of an educational program performing a play or a story telling on a computer, a field of a presentation program, or a graphic field requiring complicated and precise work.

### DISCLOSURE

### Technical Problem

To achieve these and other advantages and in accordance with the above purpose, firstly, an object of the present invention is to provide a presentation method to assist a lecturer to easily prepare an image or simple animation and use those as educational materials.

Secondly, another object of the present invention is to provide a method to perform a class interestingly and variegatedly by explaining or discoursing while giving an animation effect on a given image, in further step-up from what simply shows images one by one in presentation.

Thirdly, another object of the present invention is to provide a computer input device and a computer system suitable for this multimedia presentation.

### Technical Solution

To achieve these and other advantages and in accordance with the purpose of embodiments of the invention, as embodied and broadly described, the present invention provides a method of story telling presentation using a computer, the method comprising: embedding multimedia objects including a plurality of images relevant to a specific story, a subject forming a story or a specific subject into an execution file, a system or a server using an usual computer and dumping the multimedia objects on a screen of the computer; and selecting one of the dumped objects and arranging the one of the dumped objects at a certain position on a canvas or stage of a middle portion of the screen or a background screen.

Further, the present invention provides a method of story telling presentation using a computer, the method comprising: making main contents of educational materials and a story book into background images and objects and embedding the background images and objects in an execution file, a system or a server, and dumping the background images and objects on a screen of the computer; selecting one of the dumped images and inputting the one of the dumped images on a canvas or stage of a middle portion of the screen or as a background screen; and selecting one of the dumped objects and arranging the one of the dumped objects at a certain position on the canvas, stage or background screen.

Further, the present invention a method of story telling presentation using a computer, the method comprising: dumping multimedia objects including images, which a user prepares, relevant to a specific story or subject on a screen of the computer; and sliding one of a plurality of background images embedded in an execution file, system or server or prepared by the user and inputting the one of the plurality of background images on a canvas or stage of a middle portion of the screen or as a background screen; and selecting one of the dumped objects and arranging the one of the dumped objects at a certain position on the canvas, stage of the middle portion of the screen or the background screen.

An icon of an object group including a plurality of object images and an icon of an background image group including a plurality of background images relevant to a specific subject each are at least one and are displayed on the screen of the computer, and when one of the icons of the object group or the background image group is selected, icons of all objects included in the selected object group or icons of all background images of the selected background image group are dumped on the screen, in dumping the objects or images on the screen of the computer.

Selecting the one of the dumped objects and arranging the one of the dumped objects on the background screen includes: determining a reference point in the canvas or stage using a pointer operated in the program; moving the pointer in a desired direction and by a desired length and determining an end point; and displaying the selected object in a square having the reference point and the end point as apexes facing each other, wherein position, size and direction of the object are determined at once.

Further, the present invention provides a method of story telling presentation using a computer, the method comprising: displaying an object on a screen of a computer; moving the object on the screen; and displaying a changed image of the object when a moving distance of the object satisfies a predetermined condition.

Further, the present invention provides a method of story telling presentation using a computer, the method comprising: displaying an object on a screen of a computer; moving the object on the screen; and displaying a changed image of the object according to a moving direction of the object.

Further, the present invention provides a method of story telling presentation using a computer, the method comprising: displaying an image of an object normally when the object is moved in a positive (+) x direction with respect to a reference point of the object, and displaying the image of the object left-side-right when the object is moved in a negative (−) x direction, in a case that the object displayed on a screen of a computer is moved.

Further, the present invention provides a method of story telling presentation using a computer, the method comprising: displaying an image of an object normally when the object is moved in a positive (+) y direction with respect to a reference point of the object, and displaying the image of the object up-side-down when the object is moved in a negative (−) y direction, in a case that the object displayed on a screen of a computer is moved.

Further, the present invention provides a method of story telling presentation using a computer, the method comprising: changing a color or brightness of a background image or object displayed on a screen of a computer by selecting one of “R”, “G”, “B” and “C” buttons along with a “+” or “−” button using a computer input device including the “R”, “G”, “B” buttons corresponding to red, green and blue, respectively, the “C” button to adjust the brightness, and the “+” and “−” buttons.

Further, the present invention provides a method of story telling presentation using a computer, the method comprising: changing a size or ratio of a object displayed on a screen of a computer by selecting one of “↑”, “↓”, “→”, “←” and “0” (Original) buttons along with a “+” or “−” button using a computer input device including the “+”, “−”, “↑”, “↓”, “→”, “←” and “0” buttons, wherein the size or ratio of the object is changed with a directional property corresponding to the “↑”, “↓”, “″”, “←” or “0” button.

Further, the present invention provides a method of story telling presentation using a computer, the method comprising: displaying an object on a screen of a computer; placing a pointer, which is operated on the screen by a pointing device connected to the computer, on the object and operating the pointing device; disappearing the pointer and designating the object when the pointing device is operated; and removing the designation of the object and appearing the pointer again when the pointing device is operated again.

Further, the present invention provides a method of manufacturing a presentation multimedia file, wherein one multimedia file is manufactured by saving contents of the presentation performed on the canvas or stage by the above-described method in time sequence, and wherein the multimedia file includes informations of the background image and reference position, size and movement of the object displayed on the screen.

Further, the present invention provides a method of story telling presentation using a computer, wherein the presentation is performed while the multimedia file manufactured by the above-described method is slided according to sequence of the presentation.

Further, the present invention provides a method of manufacturing an image file, wherein images including all objects arranged on the canvas or stage by the above-described method are saved as one image file.

Further, the present invention provides a method of story telling presentation using a computer, wherein the presentation is performed while the plurality of image files manufactured by the above-described method are slided according to sequence in a program.

Further, the present invention provides a method of manufacturing an animation file, wherein images including all objects arranged on the canvas or stage by the above-described method are captured according to a predetermined number of frames per second and saved as one animation file.

Further, the present invention provides a computer input device as an input device connected to a computer, the input device comprising: an object change button group to adjust a size or width-length ratio of an object displayed on a screen of the computer; an object move button group to move a position of the object or give an animation effect to the object; an object rotate button group to rotate the object; a color change button group to change a color of the screen or object; and a sound effect button group to adjust intensity of a sound or to repeat the sound.

Further, the present invention provides a computer system, comprising: a computer body in which operating system and application program are installed; a display device connected to the computer body; first and second pointing devices connected to the computer body and each generating a coordinate signal and an event signal to independently operate first and second pointers, respectively, displayed on the display device; and an identification signal adding means generating an identification signal to distinguish signals of the first and second pointing devices and adding the identification signal into the signal of the first or second pointing device.

Further, the present invention provides a connecting device for a pointing device, the connecting device intervened between the pointing device and a computer body, the connecting device comprising: a computer port connected to the computer body; a pointing device port connected to the pointing device; and an identification signal adding means to generate an identification signal to distinguish the pointing device with other pointing device and add the identification signal into a signal input from the pointing device.

Further, the present invention provides a method of story telling presentation using a computer connected to a plurality of pointing devices, the method comprising: displaying a plurality of pointers corresponding to the plurality of pointing devices, respectively, on one computer screen; and independently selecting or moving an object displayed on the computer screen by each pointer controlled by an input signal from each pointing device.

Further, the present invention provides a method of story telling presentation using a computer, the method comprising: connecting a computer, which is connected to a first pointing device, to a second pointing device; adding an identification signal into an input signal of the second pointing device and activating the second pointing device by a pointing device recognition module; transmitting the input signal of the second pointing device by the pointing device recognition module; and moving a second pointer and performing an event independently from the first pointing device.

### ADVANTAGEOUS EFFECTS

According to the present invention, because a method of selecting a background image, selecting and inputting an object displayed on the background, adjusting a size of the object or changing a direction of the object is very simple and intuitional, an appropriate image or animation in accord with progress of a presentation can be easily expressed.

Further, because a simple change or animation effect, such as showing and moving an actor in accord with situations of a lecture or discourse, can be given in realtime, an animated presentation can be realized.

Further, a presentation such as a play or story telling on a computer screen can simply performed. For example, a lecturer, which takes first and second pointing devices in both hands, selects an object in a program and can perform an interactive role play or story telling.

Further, two or more persons, which take first and second pointing devices, respectively, can performs an interactive role play or game such as baduk, janggi and combative sport.

In the mean time, when two monitors and two pointing devices are connected to one computer, persons each having the corresponding monitor and pointing device can an interactive game such as baduk, janggi and board.

Further, By using multi pointers, a moving distance of the pointer is reduced, and thus work time and efficiency can be improved and user's convenience can increase. Further, when both hands are used, stress due to work is distributed, and thus intensity of the stress can be reduced.

### DESCRIPTION OF DRAWINGS

FIG. 1 is a presentation screen according to an embodiment of the present invention.

FIGS. 2 to 9 are views illustrating processes of performing a presentation while images are displayed in sequence of screens.

FIG. 10 is a view illustrating a method of changing an image up, down, left and right according to a moving direction of a pointer.

FIG. 11 is a view illustrating a method of changing a direction of an image according to a moving direction of a pointer.

FIG. 12 is a view illustrating a method of giving an animation effect by alternately displaying images according to moving of a pointer.

FIG. 13 is a view illustrating an input device for a presentation according to the embodiment of the present invention.

FIG. 14 is a view illustrating input buttons set at a keypad.

FIG. 15 is a view illustrating an example that a keypad is in combination with number keys.

FIG. 16 is a view illustrating a computer system according to the embodiment of the present invention.

FIG. 17 is a program block diagram of a computer system according to the embodiment of the present invention.

FIG. 18 is a block diagram of a different type from the block diagram of FIG. 17.

FIG. 19 is a view illustrating an example that a second pointer is displayed in a specific application program.

FIG. 20 is a view illustrating an example that a connecting device is installed.

FIG. 21 is a view illustrating an example that a connecting device has a different type from the connecting device of FIG. 20.

FIG. 22 is a view illustrating a computer device including two pointing devices.

FIG. 23 is a view illustrating a computer device including two pointing devices and two monitors.

FIG. 24 is a view illustrating a computer device including a touchscreen-type monitor.

### BEST MODE

A story telling presentation method according to an embodiment of the present invention is performed basically with following processes.

A program recording the story telling presentation method according to the embodiment of the present invention is run first on a computer device such as a notebook and a desktop, and a presentation such as a lecture and explanation is performed while various images of items, actors and the like are arranged and displayed on a screen connected to the computer device. Objects such as these items and actors may be displayed on a predetermined background image.

In the mean time, in this description, a two or three-dimensional image of a character, item and the like, an animation, a text and the like displayed on the background image are referred to as the object.

Position, size, direction and the like of the object may be changed in realtime by a lecturer according to contents and progress of the lecture. The lecturer may explain or discourse while changing color, brightness and the like of the object or moving the object. Effects including color change, brightness change and weather change of the background image may be given if required.

Further, an animation effect may be given by displaying changed images according to a direction, distance or time of moving the object.

Further, a text, a chart, an educational material and the like may be arranged on the screen and explained, and the above-mentioned processes may be performed while several background images prepared are slided screen by screen.

This presentation method can induce high concentration and interest of a learner because the method gives a simple change or animation effect of appearing and moving an actor compared to simply explaining only with a picture, a table and a text.

Further, the presentation method has an advantage of showing an image or animation in realtime corresponding to progress of explanation, discourse or conversation, differently from things such as play, doll play, animation and movie manufactured for one-sidely watching, and the presentation method supports simply performing a play using a computer.

Hereinafter, a method to express an image in realtime on a presentation screen and a method to give an animation effect are explained in detail.

1. Method to Express an Image

A method to express a picture-type image using various objects on a presentation screen is explained.

A presentation program according to the embodiment of the present invention provides its own various types of background images and objects. Accordingly, a user fetches those and can easily express and manufacture a picture-type image.

Further, the program may be set in a way to store these background images and objects in a kit-type storing means which is attach or detached outside of a computer, fetch those on the program of the present invention and display those.

Further, the background images and objects may be supplied in a way to set up a basic program in the computer and stream or download those from a service sever connected to the computer via an internet network.

Hereinafter, the presentation method is explained with assumption that basic background images and objects are installed in the program.

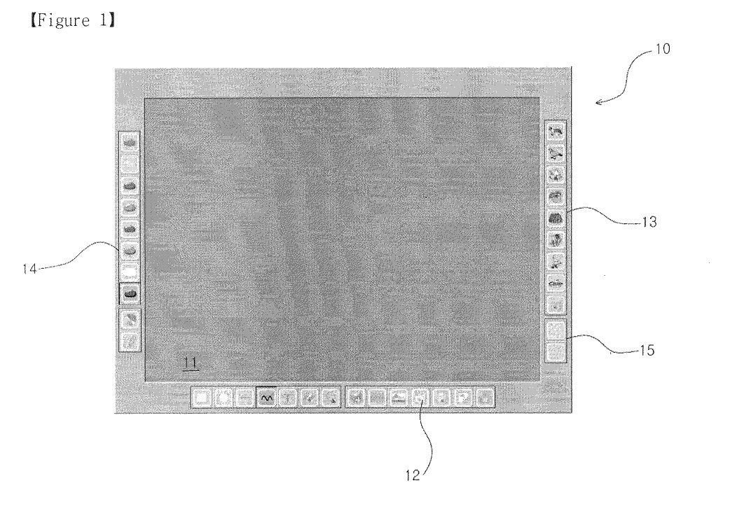

FIG. 1 is a presentation screen 10 provided by the presentation program according to the embodiment of the present invention. The presentation screen 10 includes a canvas 11 displaying background images and objects which a user selects. A tool selecting window 12, an object group select window 13, a color select window 14 and a special effect select window 15 are arranged around the canvas 11.

In the tool select window 12, a background setting button and a plurality of buttons including line-draw, figure-draw, font-adjust, save, fetch and color-fill buttons are displayed.

Because the presentation program provides its own various background images and objects, it is desirable that various types of objects are categorized into a plurality of object groups each having a common feature for a user to simply search and select background images or objects stored.

For example, in the object group select window 13, a plurality of object group icons each representing the corresponding object group, and a folder search button to call folders linked to remaining object groups which are not displayed due to limitation of a screen space.

The color select window 14 includes a plurality of color buttons including red, blue, yellow, black and green buttons for the user to select a desired color without complicated handlings and provides a color adjust menu to adjust color in detail.

The special effect window 15 gives a special effect such as snow and rain on the canvas 11 after the background and object selected by the user are displayed.

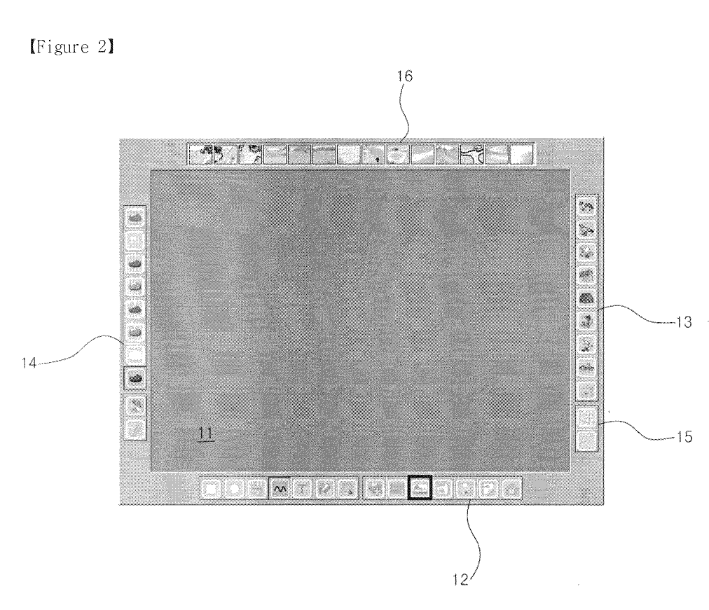

Hereinafter, processes of expressing various object images on the presentation screen according to progress of a discourse are explained with reference to FIGS. 2 to 9.

The presentation program according to the embodiment of the present invention is run first, and the presentation screen of FIG. 1 is displayed. As shown in FIG. 2, when a background setting button (as represented by a square) of the tool select window 12 is clicked, the background select window 16 including the plurality of background icons is displayed at a top portion of the canvas 11.

Subsequently, as shown in FIG. 3, when the user select one background icon in the background select window 16, the selected background image 11 is displayed on the canvas 11.

The user selects an object such as character, text and item to express on the background image according to progress of the presentation. To do this, as shown in FIG. 4, the user selects a desired object group icon, for example, an icon having a log cabin picture in the object group select window 13.

When the user selects one object group icon, an object select window 17 is displayed instead of the background select window 16. In the object select window 17, all objects included in the selected object group are dumped. The user may click one object icon and select a desired object.

As described above, the method to dump and show the all objects included in the object group on the presentation screen such that the user visually confirms those when the user selects one object group icon in the object group select window 13 is much differentiated from a method provided in the prior art graphic tool.

In the prior art method, a desired object is selected on a graphic tool through (1) a process of selecting an open menu or icon to fetch an object image, (2) a process of searching a folder, (3) a process of opening the folder and confirming image files included in the folder, (4) a process of selecting an image file and press a confirm button, and (5) a process that the selected file is opened.

Even though an image viewer or browser is supported in the graphic tool, the above (1) and (2) processes should be necessarily performed. If the image viewer and the browser is not supported, the desired object image should be searched by running an image viewer or browser program which loads and shows all images and this takes much time and many processes.

Further, in the prior art method, even in a case that other object image is searched after one object image is selected, the same processes should be conducted all over again. Accordingly, the prior art method is unsuitable for the presentation which should fetch various objects on occasion.

In the presentation program according to the embodiment of the present invention, when the user selects the representative icon of the object group displayed on the presentation screen, all object images of the group (or folder) are loaded on the program and the object select window 17 are dumped by its own viewer, and then when the user clicks one of the dumped object icons, selecting of the image is completed. (dump and select method).

Further, as described above, in the presentation program according to the embodiment of the present invention, the folder search button is provided to search objects not included in the object groups displayed on the presentation screen.

Accordingly, when the user selects the folder search button, a plurality of folders are displayed on the screen and the user searches a folder including a desired object group.

Subsequently, when the folder is search and selected, all object icons included in the selected folder are dumped on the object select window on the screen and the user selects a desired object icon.

According to the object select method, because various objects are dumped such that the user visually confirms those easily on the presentation screen, processes of selecting other image after the user selects one image is simplified.

In the mean time, the plurality of object icons dumped on the object select window 17 are selected by putting and clicking a mouse pointer, and it is desirable that, in a case that one object icon is selected, even though the user takes his finger off the mouse button, the selected state is maintained.

As shown in FIG. 5, when the user pulls the mouse pointer by a desired length and in a desired direction in a state that the user put the mouse pointer on a desired position and press the mouse button and then the user takes his finger off the mouse button, the selected object is displayed on the canvas 11.

A size of the object is automatically adjusted corresponding to a size of a rectangle having a start point and an end point of the mouse pointer facing each other. When the size of the object is adjusted over again, enlarge/reduce buttons set at a keyboard or other input devices are used.

When the position of the object is adjusted over again e.g., the object is moved, the mouse or an arrow button of the keyboard or other input devices is used.

The press and pull method, compared to the prior art drag and drop method, includes (1) a process of pressing the mouse button and selecting the object, (2) a process of dragging the object to a desired position in the state of keeping the mouse button pressed, and (3) a progress of taking the finger off the mouse button and placing the selected object at the desired position.

However, in the prior art drag and drop method, because the object is moved in an original size, a size adjustment of the object should be separately performed after the object is placed at the desired position, and because the object is moved in an original state, a direction adjustment of the object should be separately performed.

Accordingly, because selection and movement of the object take many processes and continuity is broken, the prior art method has a problem that it is not suitable for the multimedia presentation.

In the press and pull method of the present invention, it is not needed to keep the mouse button pressed from selection the object to placement of the object at the desired position. After the object is selected, the mouse pointer is put at the desired start point then pulled by the desired length in the desired direction and then the finger is taken off the mouse button at the end point. Accordingly, selection, position designation and size adjustment of the object are simplified.

Further, a direction of the object image is easily changed according to the pulling direction.

Further, because the object continues to be in the selected state before the user selects other object, identical objects can be displayed to an unlimited extent on the canvas 11 with mouse handlings without a separate process of selecting the object. Accordingly, it is advantageous to display a group having identical objects.

Further, the objects can be independently placed on the background image and be independently moved. The press and pull mode can be used for the presentation such as a basic mathematics education.

It is desirable that the background images and the objects displayed on the background images are classified and provided according to story and subject in the program such that the user gains an easy access.

Table 1 as below is a classification table exemplifying background images and objects which can be used for a story telling regarding “General Soon Shin Lee”.

In other words, the background images may include military camp, sea, straits, map, land, deck and inside of a ship. The objects may include central figures (Soon Shin Lee, Kyun Won, and the like), ships (Tutle Ship, japanese ship, and the like), soldier, farmer, natural or structural objects (castle, island, rock, sea gull and the like), battle figures (cannon shooting figure, spear throwing figure) and horse.

TABLE 1
Subject: General Soon Shin Lee (story book or specific story)

| | |
|---|---|
| background | military camp 1, military camp 2, sea, straits 1, straits 2, |
| image | map, land, deck, inside of a ship |
| object | \textcircled{1} central figures: Soon Shin Lee 1, Soon Shin Lee |
| | 2, Kyun Won, and the like |
| | \textcircled{2} ships: Tutle Ship, Japanese ship, fishing ship, |
| | and the like |
| | \textcircled{3} persons e.g, soldier: training figure, farmer, |
| | and the like |
| | \textcircled{4} natural objects, structural objects, and others: |
| | castle, island, rock, sea gull, and the like |
| | \textcircled{5} battle figures: cannon shooting figure, spear throwing |
| | figure, and the like |
| | \textcircled{6} others: moving by horse riding, moving foods, refuge, |
| | and the like |

The user may designate the background images prepared as above at his disposition. The appropriate background images may be sequentially displayed in accord with progress sequence of a story or scenario rather than the user's selecting every background image. For example, the background images such as japanese ship appearing figure, ambushing figure, attacking figure and winning figure are sequentially displayed whenever the user presses a slide button. This can prevent confusion of a lecturer.

Table 2 as below is a classification table exemplifying background images and objects for a story telling or presentation regarding “rural life”.

TABLE 2
Subject: rural life(subject to make a story on)

| | |
|---|---|
| background | mountain, valley, field, brook, faddy field, dry field, lake, |
| image | house, stock farm, and the like |
| object | \textcircled{1} moving person: walking, luggage-carrying, and the like |
| | \textcircled{2} work, others: rice-threshing, shovelling, building, |
| | and the like |
| | \textcircled{3} vehicle: tractor, carriage, handcart, truck, |
| | and the like |
| | \textcircled{4} garden product: apple tree, cabbage, and the like |
| | \textcircled{5} moving animal: dog, frog, and the like |
| | \textcircled{6} flying bird, insect: sparrow, butterfly, and the like |

The background images may include various images such as mountain, valley, field, brook, faddy field, dry field, lake, house and stock farm. On the background image, various objects such as person, vehicle, farm product and animal may be displayed.

When the object is selected and attached on the background image, if a change of direction or animation effect is given, an animated effect can be achieved. To this, when the objects of the groups \textcircled{1} to \textcircled{5} are selected and attached, the images may be changed in a left or right direction, and when the objects of the group \textcircled{6} are selected and attached, the images may be changed in a up, down, left or right direction.

Further, when the objects of the groups \textcircled{1}, \textcircled{3} and \textcircled{5} are selected and moved, the images may be changed or the animation effect may be performed along an x axis, and, when the objects of the group \textcircled{6} are selected and moved, the images may be changed or the animation effect may be performed along a y direction.

These image change and animation effect methods are explained later.

In the mean time, in the presentation program of the embodiment of the present invention, the background images and objects are installed in the program, fetched in realtime by the user and displayed, but also text may be fetched and displayed.

When the text is fetched, it is desirable that the text is sequentially fetched part by part according to sequence of a lecture or story. To do this, for example, an Enter key may be used as a text dividing unit.

The text may be provided by the program itself, be a file name of an object fetched, or be input by the user.

The text may have position and size adjusted through the press and pull method.

In the mean time, the presentation program of the present invention provides means to easily change the direction of the selected object.

In other words, the desired is selected, then the mouse pointer is put at the desired position, then the mouse button is pressed, then the mouse pointer is pulled, and the direction of the image is changed according to the direction of pulling the mounse pointer.

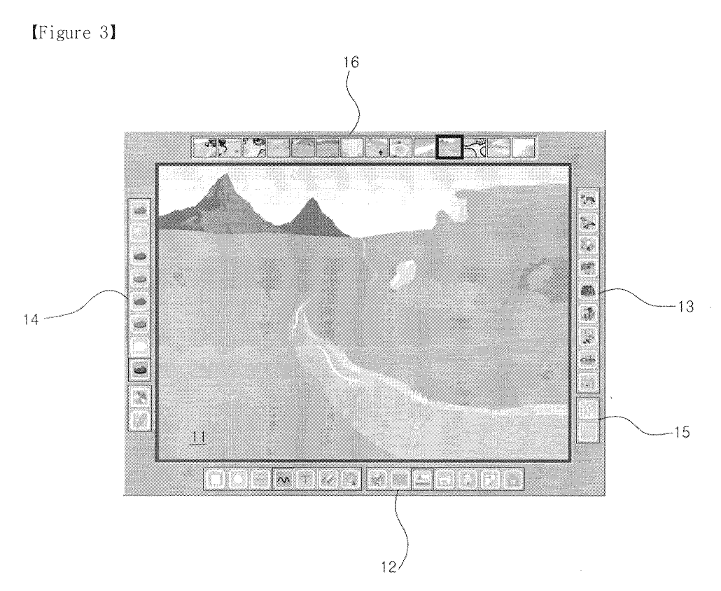

For example, as shown in FIG. 10, when the mouse pointer is moved in a direction (+x, −y) with respect to an initial position (start point), a normal image is displayed. When the mouse pointer is moved in a direction (+x, +y), an up-side-down image is displayed. When the mouse pointer is moved in a direction (−x, −y), a left-side-right image is displayed. When the mouse pointer is moved in a direction (−x, +y), an up-side-down and left-side-right image is displayed.

For more convenience, with respect to a x component of the moving direction, an normal image may be displayed for moving in a +x direction direction, and a left-side-right image may be displayed for a −x direction direction. Alternatively, with respect to a y component of the moving direction, a normal image may be displayed for moving in a +y direction direction, and an up-side-down image may be displayed for a −y direction direction.

These direction change technique may apply to the object such as person, ship, vehicle and animal exemplified in the Tables 1 and 2.

In the prior art, to change a direction of an image, a direction change menu provided in a graphic tool is used, or a direction or angle to change is selected after a direction change conversation window is fetched from an editing menu. Accordingly, processes are complicated.

Accordingly, for the multimedia presentation for which a realtime expression is important, the direction change method of the present invention can be used more usefully.

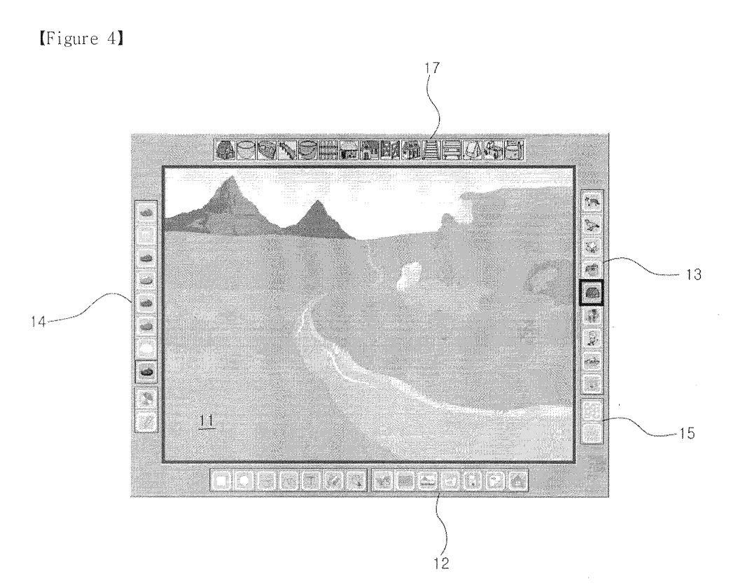

The direction of the object 11 displayed on the canvas 11 is changed using direction change keys set in a keyboard or other input device. In addition, as shown in FIG. 11, the embodiment of the present invention provides a direction change method that, according to a moving direction of a mouse pointer on an object, object images set in different directions are displayed.

For example, there are four angle zones divided with respect to a center point of an original image (a). When a mouse pointer is moved within an angle range of a first angle zone 1, a normal image is displayed. When the mouse pointer is moved within an angle range of a second angle zone II, an image (b) rotated by 180 degrees angle with respect the original image (a) is displayed. When the mouse pointer is moved within an angle range of a third angle zone III, an image (c) rotated counterclockwise by 90 degrees angle with respect the original image (a) is displayed. When the mouse pointer is moved within an angle range of a fourth angle zone IIII, an image (d) rotated clockwise by 90 angle degrees with respect the original image (a) is displayed. The angle ranges and image directions may be further subdivided.

This method may give an animated visual effect not only when a direction of a static object is changed but also when the object is being moved. For example, in a case that the butterfly character is being moved using the mouse, because a head direction of the butterfly is changed whenever the moving direction is changed, realistic feeling is given.

Further, because a user easily handles the direction change, a lecturer can easily play an animation effectively during a multimedia presentation.

In the meantime, FIGS. 6 to 8 shows processes of displaying various objects on the canvas 11 additionally.

When this presentation program is used, because, during a lecture or discourse, appropriate objects are displayed in accord with situations and the situations are visually expressed, a realistic lecture can be performed.

If required, color of the object or text input through the color select window 14 may be changed, and a snowing effect may be given using buttons provided in the special effect select window 15, as shown in FIG. 9, and besides, raining, thunder, lightening or the like effect may be given.

As the method of displaying this special effect, there are a method of displaying directly on the object and background image, and a method of putting a transparent layer on the entire screen and displaying the special effect image such as brightness change, color change, rain, snow, sun, cloud, wind, lightening and thunder, or animation.

The special effect may be displayed using the image or animation supported in the program of the invention. Besides, the user may directly write a text, draw a picture, or give a graphic effect using mouse, electronic pen and the like.

Through the processes as described above, when the picture-type image including the background, various objects and special effects on the canvas 11 is completed, the completed picture may be saved as one image file by pressing the save menu of the tool select window 12, or the completed picture may be automatically saved as a designated name in a designated folder using a save button of an input device.

In the mean time, a name of the object displayed on the presentation screen may be displayed in Korean, English and the like. To do this, as shown in FIGS. 5 to 9, in the program of the present invention, a text window, on which a name of a certain object appears at the top and left portion of the presentation screen when the lecture selects the object, is set.

The text displayed on the text window may be displayed on the background image through the press and pull method after the user clicks and selects the text using the mouse, in similar to processes of displaying the image.

Because the text may be selectively displayed in Korean or foreign language, the program of the present invention can be used usefully for language learning of an infant or child.

For example, when one object icon is selected in the object select window 17, the name of the corresponding object is displayed in Korean or foreign language on the text window at the top and left portion of the screen. The object is displayed on the presentation screen through every possible methods such as drag and drop, press and pull, and select and locate, and then the text (Korean or foreign language) is displayed beside the object in the same manner. This can be used usefully for word learning.

For a more animated effect, when a mouse pointer is placed on an object or text and the mouse button is clicked, a name of the object or pronunciation of the text sounds.

Further, it may be set that, when a mouse pointer is placed on an object and the mouse button is pressed, a sound representing the object, for example, animal's crying sound, is output, and when the mouse button is unpressed, the sound is terminated.

Further, to avoid keeping a mouse button pressed while an object is moved, it may be set that, when the mouse pointer is placed on the object and the mouse is clicked, the object is selected, and, to see a fact that the object is selected, the mouse pointer is not shown and the selected object is activated and displayed.

It may be set that, when the mouse button is clicked again after the object arrives at a desired position, the selected object is placed at a final position and the mouse pointer is displayed again.

For example, when a baduk-piece is clicked, a mouse pointer is not displayed and the baduk-piece is displayed, and, in this state, even though the mouse button is not pressed, the baduk-piece is moved to a desired position. In a moment when the object such as the baduk-piece and the like is selected, a predetermined sound effect is outputted or an animation effect is given.

When the above-described image expression method applies to the presentation program, because following effects can be obtained, the presentation can be easily performed effectively.

(1). A background image can be easily searched and input.

(2). An object, item and the like to display on a background can be easily searched and inputted.

(3). Size adjustment of an object is easy and intuitional.

(4). Direction adjustment of an object is easy and intuitional.

(5). A selected object can be easily drawn on a background and attached on the background many times.

(6). Editing process and image fabricating time can be reduced remarkably.

(7). Even a person who does not draw a picture well can easily edit and get a desired image.

(8). Input of a prepared text is easy and simple.

(9). Font adjustment of a text to input can be automatically performed.

2. Method of Expressing an Animation

The above-described image expression method is for manufacturing the picture-type static image on the canvas 11 using the background image or object provided in the presentation program of the present invention or fetched by the user.

However, it is desirable that an active animation is appropriately added for a presentation to be more realistic.

From this point of view, changing a direction of an object according to a moving direction of a mouse or adding a special effect such as snow, rain, thunder and lightening may be a simple type of an animation.

In further progress, a method of adding an realistically moving effect to an object displayed on a presentation screen is explained.

The prior art animation technique is a method to give a feeling that a certain object is moving by manufacturing screen-sized (or canvas-sized) images where figures of the certain object are changed bit by bit and then making those as one file, and displaying several or several tens of images per second on the screen. In other words, the prior art animation technique is a method to display a changed image per predetermined time on the screen.

However, because the images having the size of the canvas 11 should be prepared in advance, the prior art method spends much manufacturing time and is not appropriate to impromptu give simple animation effects corresponding to situations during a multimedia presentation.

The presentation program according to the embodiment of the present invention provides a method to give a simple animation effect for each object during a multimedia presentation.

An animation expression method that a certain object is selected and displayed on a background image of the canvas 11 and changed images are displayed per a predetermined distance when a user takes and moves the displayed object in a certain direction using a mouse is provided.

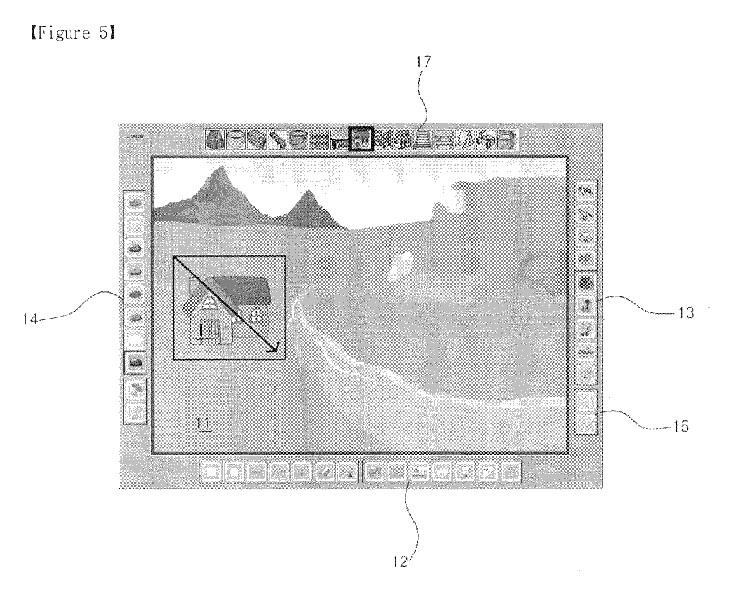

For example, as shown in FIG. 12, a reference position of an object is at a position x1 on a x coordinate, and the object is pulled in an x direction using a mouse. When the reference position passes through a position x1+a, a changed image is displayed, and then, when the reference position passes through a position x1+2a, an original image or a second changed image is displayed.

“a” is a predetermined distance in the x direction and is set within an extent to give a minimum animation effect. The original image and changed images of the object are mapped and saved.

Accordingly, while the object is pulled in the x direction using the mouse, the object is changed into various images and displayed or it appears that the object runs. The method applies to in a case that the object is moved in a y direction.

In other words, even when the object is moved in the x direction and then turned and moved in the y direction, the changed images may be displayed. When the mouse pointer is moved in the x direction, the effect of running in the x direction is given, and, when the mouse pointer is turned in the y direction, the object in a different direction according to the method as described with regard to FIG. 4 is displayed and then the changed images continues to be displayed according to a predetermined distance.

The played animation screen (including the background image and objects) may be captured according to a predetermined number of frames per second and saved as one animation file, and further, a sound effect and mike input sound may be saved together.

Further, while a plurality of objects are sequentially arranged on a background image, images of the screen may be captured every predetermined time interval or whenever a new object is added and the plurality of images captured may be saved as one animation file.

In this animation expression method, because the change of the image is performed according to a moving velocity of the mouse pointer on the canvas 11, a natural animation effect can be obtained even with several images.

Further, because the animation effect is given partially to each object, there is an effect that a simple play-type presentation using a computer screen as a stage can be performed.

The animation expression is not limited to active effects such as walking figure, running figure and flying figure and can apply to various figures such as expression change, feeling change, color change, size change and direction change.

For example, when a mouse pointer is placed on an object such as person and animal and pressed, moving of a mouth, hand or foot can be displayed. This can be realized through a method that an original image and continuous changed images, which are mapped and saved, of the corresponding object are sequentially displayed in short time.

In the mean time, a lecturer performs a story telling or presentation with regard to a certain subject in the above-described method, and, if the lecturer automatically saves the performed contents, the same story telling may be performed by playing the saved contents.

Table 3 illustrates processes of saving contents executed in a story telling and manufacturing a multimedia execution file.

TABLE 3

| sequence | contents | position | size | action | performance | time |
|---|---|---|---|---|---|---|
| 1 | background | (0, 0) | full screen | | start | |
| | image 1 | | | | | |
| 2 | sound 1 | | | 10 seconds | | |
| 3 | object 1 | (a, b) | (c × d) | | button | 1 second |
| | | | | | click | |
| 4 | | (a + n, b) | | n = n + 5 | 20 times | 0.1 |
| | | | | | | seccond × 20 |
| 5 | text 1 | (i, j) | font name | | | 2 seconds |
| | | | font size | | | |
| 6 | background | (0, 0) | full screen | | button | |
| | image 2 | | | | click | |

When the background image 1 is displayed, relevant information, for example, a coordinate (0, 0) of a reference position and a image size (full screen) are mapped with the background image 1 and saved.

Because an animated multimedia file can be manufactured if the first background image 1 appears along with an appropriate background sound, the sound 1 output along with the background image 1 may be determined and a time to execute this (for example, 10 seconds) may be set.

Subsequently, informations of an object on the background image 1 are saved in sequence.

For example, when the object 1 is displayed, a coordinate (a, b) of the reference position and a size (c×d) are mapped with the object 1 and saved.

In the multimedia execution file, a time when the object 1 is displayed may be set to a certain time after the background image 1 is displayed, or a time when a lecturer clicks an operation button.

A time item (1 second) in Table 3 is a minimum time when the object 1 is maintained on the screen, and the time item is set such that the object 1 is maintained during least one second and then the object 2 is displayed even though the button is pressed twice in series.

If the lecturer moves the object 1 in a x direction and displays a normal image and changed images of the object 1 and thus gives an animation effect, when the execution file is manufactured, a coordinate of the reference position of the object 1 is set to be, for example, (a+n, b) and n=n+5 and thus the position of the reference coordinate is set to be moved by five pixels in the x direction, and a time of about 0.1 second is allocated to a movement of the coordinate by one unit.

Accordingly, in the manufactured execution file, the object 1 is moved in the x direction per second and changed images are alternately displayed. If a number of movements of the coordinate is 20, the animation takes 2 seconds.

Subsequently, when the lecturer selects the text 1 corresponding to a certain object and displays the text 1 beside the certain object, relevant informations such as a coordinate (i, j) of a reference position, a font name, a font size and a minimum maintaining time (for example, 2 seconds) are saved with the text 1.

When the lecturer finishes the story telling or presentation relevant to the background image 1 through the above-described processes and selects and displays the new background image 2 on the screen, an execution file manufacturing program saves informations such as a reference coordinate and size of the background image 2.

Further, the background image 2 may be displayed at a predetermined time after the selection and movement of the object on the background image 1 is finished, and the background image 2 may appear when the lecturer click an operation button.

Through these processes, the contents of the story telling or presentation performed by the lecturer are saved as one multimedia execution file. Accordingly, the lecturer does not repeat the same story telling or presentation over again and can easily perform the story telling or presentation using the manufactured file.

3. Input Device for a Presentation

Generally, a multimedia presentation system includes a computer performing a presentation (notebook, IPTV and the like), an output device such as a display and a speaker connected to the computer, and an input device such as a keyboard, a mouse and a mike.

To perform a lecture or discourse in realtime during a multimedia presentation using the above-described digital image or animation manufacturing program, it is desirable that an input device easily handled by a lecturer is provided.

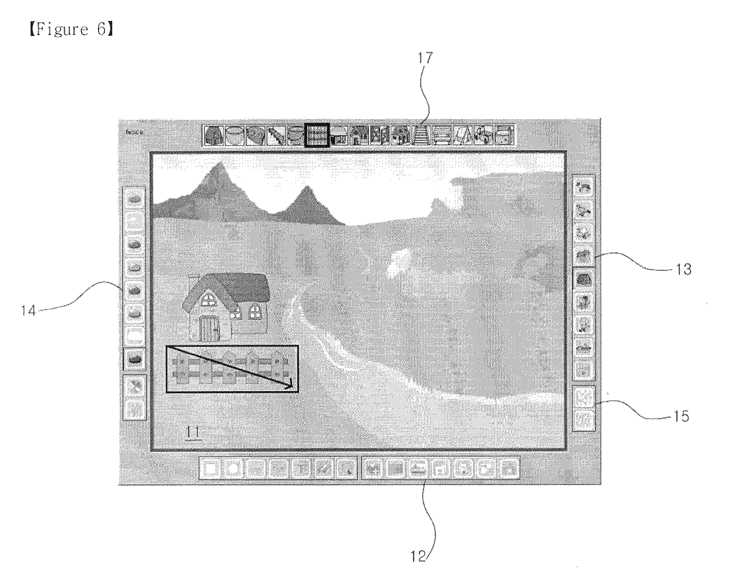

FIG. 13 is a view showing one example of an input device 20 according to the embodiment of the present invention. The input device 20 includes various buttons suitable to perform the lecture while an image or animation using the above-described program is shown.

A plurality of button groups are arranged in a middle portion of the input device 20. For example, the plurality of button groups includes a screen change button group 21, a sound effect button group 22, a special effect button group 23, a color change button group 24, an object change button group 25, an object move button group 26 and an object rotate button group 27.

The screen change button group 21 adjusts a screen change or size. For example, the screen change button group 21 includes “previous, next and screen” buttons. The screen button changes a canvas into a full screen or normal screen.

The sound effect button group 22 includes “down and up” buttons to adjust volume, a “repeat” button to listen repeatedly, and a “effect sound” button.

The special effect button group 23 gives a special effect on the screen, and includes “wind, snow, rain, thunder and lightening, and cloud” buttons.

The color change button group 24 changes color of the screen or object, and includes “red, green, blue, bright, dark and gray” buttons. The color change button group 24 includes a “color” button to restore a changed color to an original color.

The object change button group 25 adjusts size or width-length ratio of the object, and includes “tall, short, thick, thin, large and small” buttons.

The object change button group 25 includes “original” to restore a changed size to an original size.

The object move button group 26 gives moving or an animation effect of the object, and includes “left, right, up and down” buttons.

The object rotate button group 27 rotates an image of the object, and includes an “up-side-down” button to change the image up-side-down, an “left-side-right” button to change the image left-side-down, and a “rotate” button to rotate the image, for example, rotate clockwise the image by 15 degrees angle per click.

Further, the input device 20 may be used with a mouse or joystick, and to do this, it is desirable that a mouse pad 28 is provided or the joystick is set up around the input device 20.

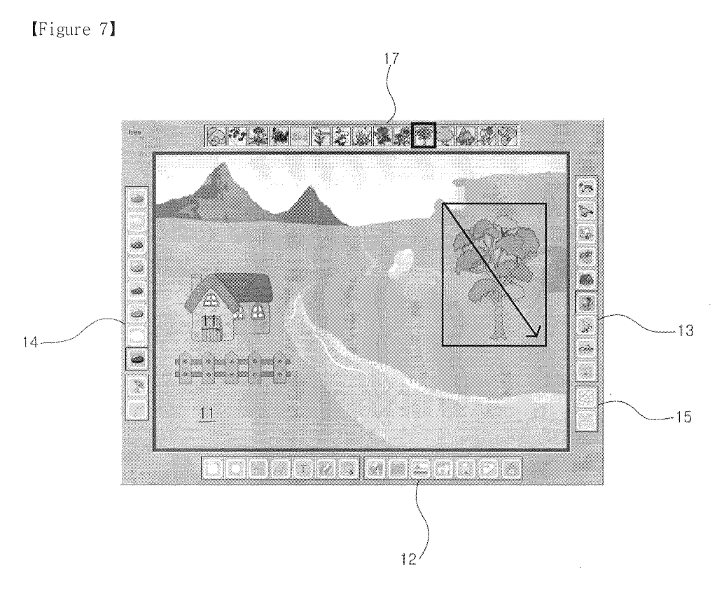

To use the image and animation manufacturing program according to the embodiment of the present invention, the separate input device 10 may be fabricated, as shown in FIG. 13, and a keypad 30 may be set at a typical keyboard, as shown in FIG. 14.

In FIG. 14, a “screen” functions to display an image drawn on a canvas with a full screen or restore to the original screen. “up and down” functions to display previous and next screens, respectively.

Further, a “C” (color) adjusts brightness of an object. The brightness is adjusted by pressing the “C” button along with a “+” or “−” button after an screen or object of which the brightness is supposed to be adjusted is selected. The “C” button may be pressed in a state that the “+” or “−” button is pressed, or the “+” or “−” button may be pressed in a state that the “C” button is pressed.

All color may be represented by R(red), G(green) and B(blue) values. Generally, values of each of R, G and B are divided in 256 levels of 0^{th} level to 255^{th} level, and as the value increases toward the 255 level, the brightness increases.

Accordingly, for example, in a state that the RGB values of the object are current RGB values (A, B, C), when the user presses the “+” button along with the “C” button, the current RGB values increase by a predetermined value (for example, 10 levels) and become RGB values (A+10, B+10, C+10) and thus brightness increases, and when the user presses the “−” button along with the “C” button, the current RGB values decrease by a predetermined value (for example, 10 levels) and become RGB values (A-10, B-10, C-10) and thus brightness decreases.

Further, the color of the screen or object can be adjusted using the method of adjusting the RGB value as described above. For example, when the “+” button is pressed along with a “R” button of the keypad 30, the R value of the RGB values increases by a predetermined value and the screen or object is changed to be more red.

When the “−” button is pressed along with the “R” button of the keypad 30, the R value of the RGB values decreases by a predetermined value and the screen or object is changed to be less red.

When the “+” or “−” button is pressed along with the “R” button of the keypad 30, the R value of the RGB values increases or decreases by a predetermined value, and at the same time, the G and B values may increase or descrease by a predetermined value.

Likewise, When the “+” or “−” button is pressed along with a “G” or “B” button, the G or B value may be changed and color of the screen or object may be changed.

Arrow buttons such as “↑, →, ↓, ←, [symbol] , [symbol] , [symbol] and [symbol] ” moves the object. When the arrow button is pressed, the selected object may be moved in the direction of the arrow button. When the arrow button is pressed along with a “Ctrl” button, a direction of the object may be changed in the direction of the arrow button, in similar to using the mouse in FIG. 4.

Further, a size of the object may be adjusted using the “+” or “−” button along with the arrow button. For example, when the “↑” button and the “+” button are pressed together, the selected object gets tall, and when the “↓” button and the “−” button are pressed together, the object gets short. Further, when the “→” button and the “+” button are pressed together, the object gets thick, and when the “←” button and the “−” button are pressed together, the object gets thin.

Further, when a “0” button and the “+” button are pressed together, the size of the object gets large, and when the “0” button and the “−” button are pressed together, the size of the object gets small.

The “+” or “−” button may be pressed in a state that the arrow button or “0” button is pressed, or the arrow or “0” button may be pressed in a state that the “+” button or “−” button is pressed.

Besides, a “sound” button functions to play a specific effect sound set for each object or other special effect sound (a sound according to moving of the object, a sound colliding with other object, and the like).

When the “sound” button is pressed, the sound set is played. When the “sound” button is pressed along with the “+” button, the volume is up, and when the “sound” button is pressed along with the “−” button, the volume is down.

“rain”, “snow” and “wind” buttons are for a special effect. When the “rain”, “snow” or “wind” button is along with the “+” or “−” button, intensity of rain, snow or wind increases or decreases.

Further, when the “Ctrl” button and the “rain” button are pressed together, thunder and lightening may be displayed together.

A “save” button is for saving. When the “save” button is pressed, an animation manufactured on the program may be saved, and when the “save” button is pressed along with the “ctrl” button, an current image may be saved.

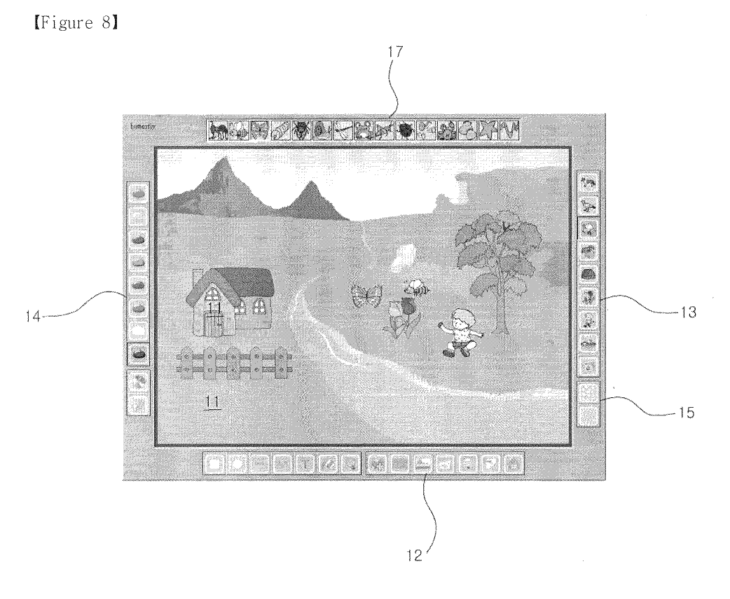

The keypad 30 may be used with a number keypad, as shown in FIG. 15, and in this case, it is desirable that a select key 40 is set up at one side and a user selects usage of the keypad for the presentation according to the embodiment of the present invention or for a typical number key.

Besides this keypad-type input device, a touchscreen-type input device may be provided, or an input device may be installed inside a program in a toughscreen-type computer.

These devices have an advantage of being used usefully for enducation or game for an infant or child because a user can intuitionally select and move the object through a screen even though the user does not look at the complicated keypad.

4. Multi Pointing Devices

When the above-described play or story telling is performed through a computer system where one pointing device is connected to a computer body, because one object is moved or selected at the same time, there is a limitation in maximizing effect of a presentation.

Accordingly, to overcome this limitation and increase effect of a play or presentation performed in a computer, the embodiment of the present invention suggests a computer system where at least two pointing devices are connected to one computer and the pointing devices are operated independently.

The pointing device includes a movement sensing means such as a ball or ray and a handling means such as a button, and functions to transmit a coordinate information taken by the movement sensing means and an even information generated by handling to the computer body. The pointing device includes mouse, joystick, trackball and touchpad.

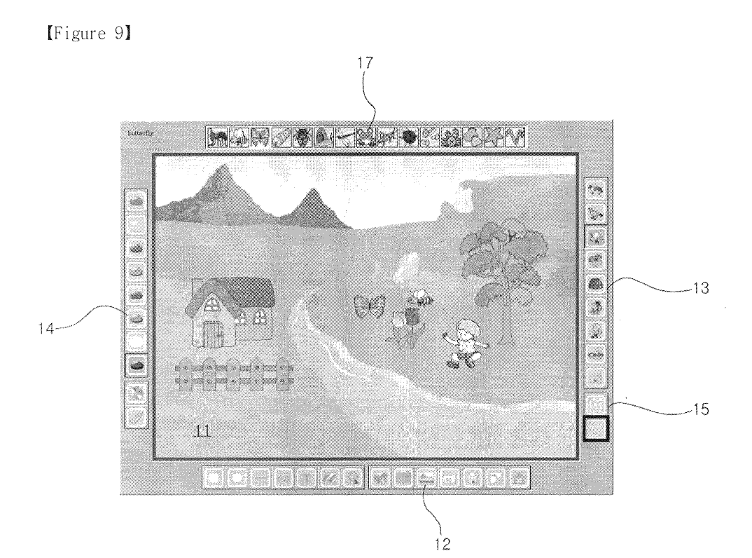

FIG. 16 is a schematic view of a configuration of a computer system 100 according to the embodiment of the present invention. The computer system 100 includes a computer body 130, first and second pointing devices 110 and 120 as input means connected to the computer body 130, and a monitor 140 as an output means connected to the computer body 130.

The present invention has a feature that two pointing devices 110 and 120 are connected to the computer body 130 and first and second pointers 141 and 142 are independently displayed and operated by the first and second pointing devices 110 and 120, respectively.

More than two pointing devices independently operating respective pointers come within a scope of the present invention. For explanation convenience, as shown in FIG. 16, a case of using the two pointing devices is explained.

Each pointing device 110 and 120 generates a coordinate information relevant to moving of the corresponding pointer 141 and 142 and an event information such as clicking of a button by a user and transmits those to the computer body 130.

The computer body 130 includes a processor 133 processing informations according to a program, a main memory 134 storing a system operating program and an application program, a RAM 135 for running a program and storing data, and a monitor connecting portion 136 providing a connection interface to the monitor 140.

Further, the computer body 130 includes first and second pointing device connecting portions 131 and 132 providing connection interfaces to the first and second pointing devices.

A desktop computer, a notebook computer, PDA (Personal Digital Assistants), PMP (Portable Multimedia Player), PSP (Play Station Portable), navigation device, game device, digital TV and the like may be provided as the computer system 100.

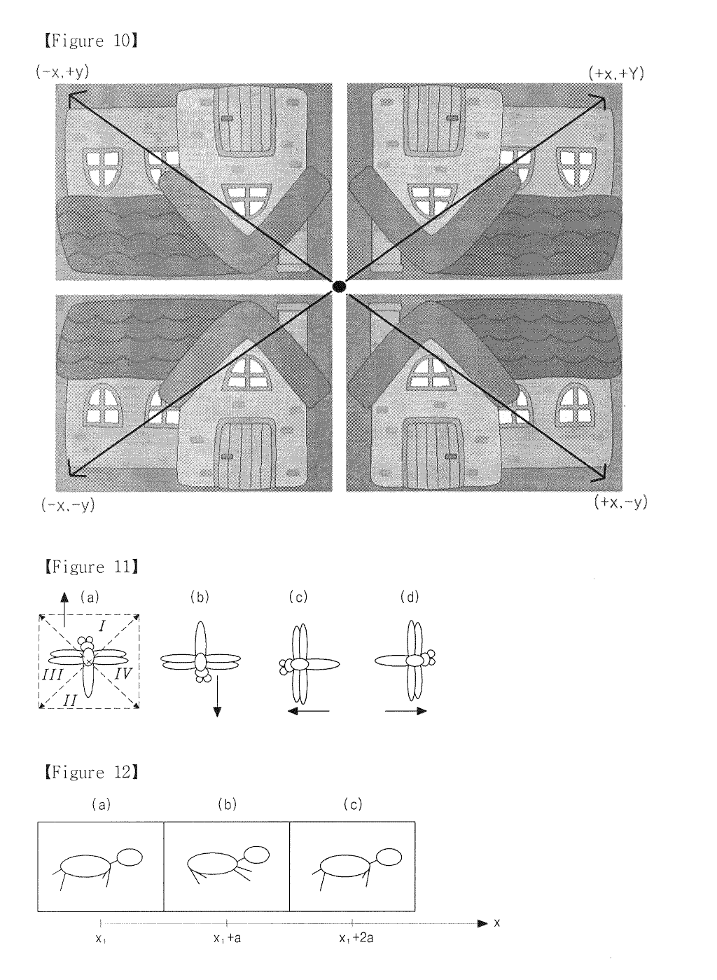

From point of view of a program, the computer system according to the embodiment of the present invention may be represented by a block diagram of FIG. 17.

In other words, an operating system program 200 providing a GUI (Graphical User Interface) between a user and a computer is linked to a first pointing device recognition module 210, a second pointing device recognition module 220, a monitor interface module 230, an application program 240 and the like.

The first and second pointing device recognition modules 210 and 220 are programs functioning to process signals input from the first and second pointing device connecting portions 131 and 132 and generate the pointers on the monitor 140, respectively, and recognize moving or clicking action and move the coordinates of the pointers 141 and 142 or run a specific program.

It is desirable that the first and second pointing device recognition modules 210 and 220 are integrated as one. However, the first and second pointing device recognition modules 210 and 220 may be provided as independent programs.

In the mean time, as shown in FIG. 17, when the first and second pointing device recognition modules 210 and 220 are arranged at the same level as the application program 240, the first and second pointers 141 and 142 may be moved on the entire monitor screen.

In the mean time, if the second pointing device 120 has the same level and function as the first pointing device 110 in the recognition modules, the second pointer 142 operates overall at the operating system and the programs embedded in the computer as the first pointer 141 operates and a plurality of programs are concurrently run by using a plurality of pointers may occurs, and thus this causes confusion of a user. Accordingly, it is more desirable that the first pointer 141 is used at the same level as the operation system and, and the multi pointers are used if required, for example, only when a specific application program supporting the story telling, play, and an interactive game is run.

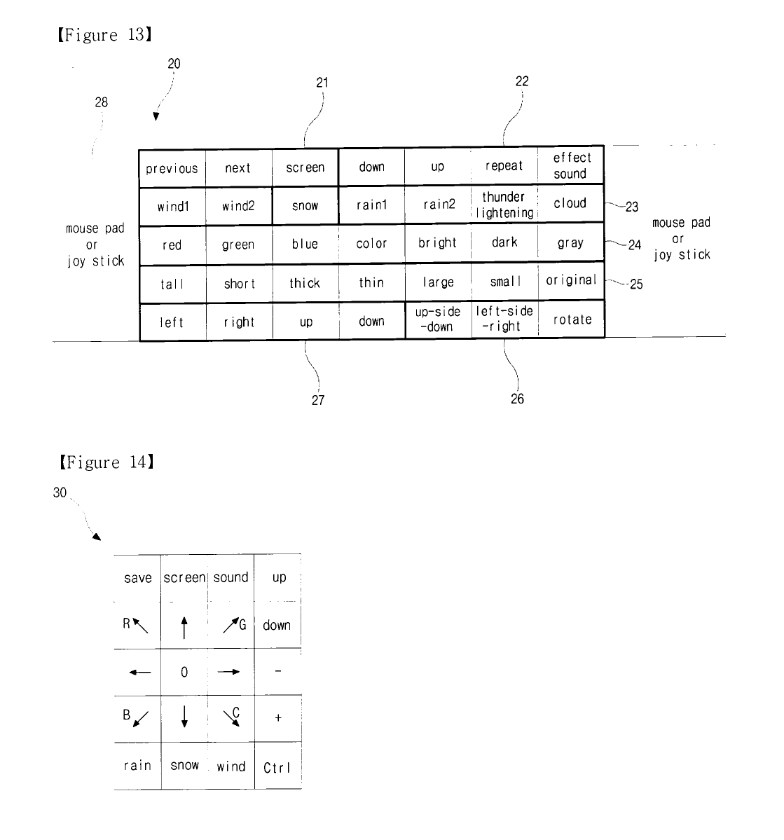

In a case that the multi pointers are used only when the specific application program is run, the second pointing device recognition module 220 is arranged such that the second pointing device recognition module 220 is included in or linked to the specific program 240, as shown in FIG. 18, and thus the second pointing device recognition module 220 is run only when the specific application program is run.

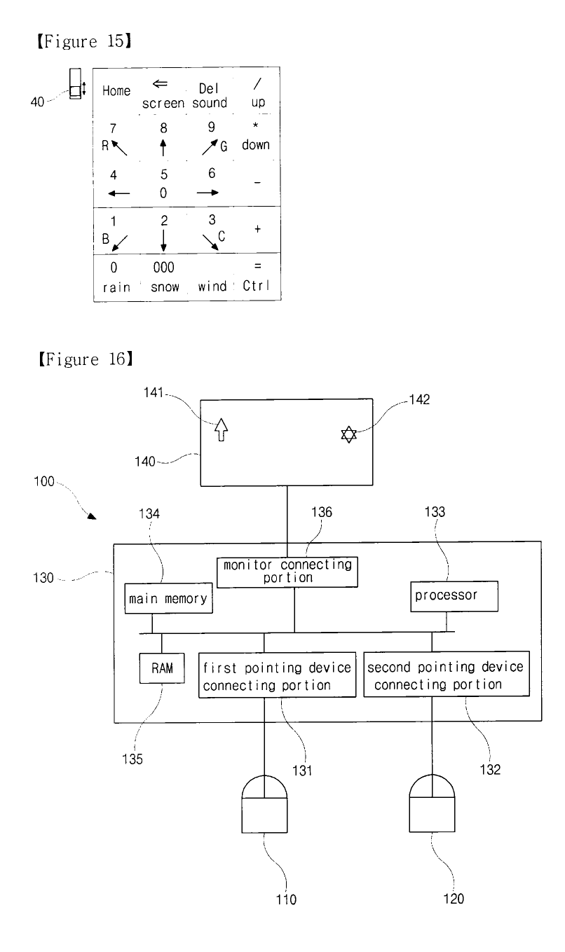

Accordingly, the first pointer 141 as a basic pointer is usually moved at programs including the operation system. However, when the specific application program is run, the second pointing device recognition module 220 is activated and, as shown in FIG. 19, the second pointer 142 is generated and displayed in an execution screen.

While the second pointer 142 is moved in the execution screen of the relevant program, the first pointer 141 is controlled by the first pointing device recognition module 210 as a basic recognition module and thus the first pointer 141 can be moved on the entire monitor screen and operated in the execution screen of the application program.

Accordingly, the activated two pointers are operated independently in the execution screen.

The coordinate informations or event informations input to the computer body 130 by each of the first and second pointing devices 110 and 120 are used to update position of each of the first and second pointers 141 and 142 and execute the application program 240 or other application program by each of the first and second pointing device recognition modules 210 and 220.

In the mean time, it is desirable that the first pointer 141 is controlled by a signal processed in the first pointing recognition module 210 and the second pointer 142 is controlled by a signal processed in the second pointing recognition module 220. However, one pointing device recognition module may recognize and distinguish the first and second pointing devices and perform signal process. For example, one pointing device recognition module (for example, mouse driver) may distinguish the first and second pointing devices according to order in which the devices are connected to the computer or which is arbitrarily allotted to the devices, or whether an identification number exists or not.

To prevent confusion of a user, it is desirable that the first and second pointers 141 and 142 have different color or shape.

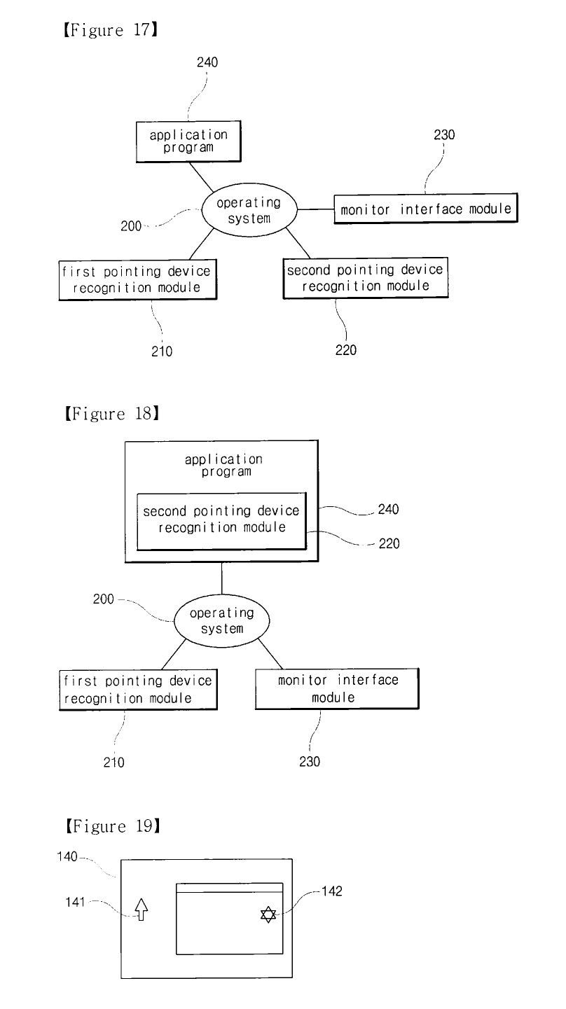

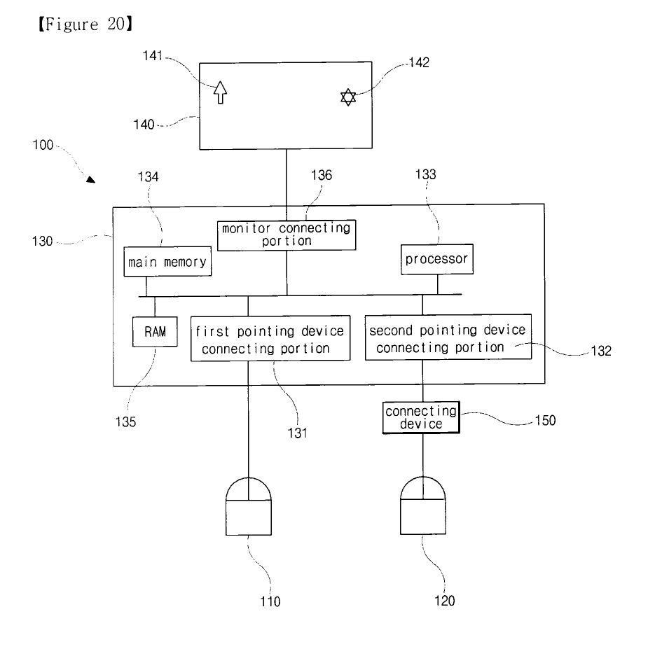

Hereinafter, a method of distinguishing and recognizing pointing devices connected to the computer body 130 as the first pointing device 110 and the second pointing device 120 with reference to FIGS. 20 and 21.

A first method is to make a differentiation between electric signals generated in the first and second pointing devices 110 and 120 and transmitted to a processor 133 of the computer body 130.

For example, by adding an identification number (for example, a predetermined bit pattern), which makes a differentiation with a signal of the first pointing device, into a signal generated and input from the second pointing device 120, the input signal may be processed by the second pointing device recognition module 220.

This identification number may be generated in the second pointing device 120, and alternatively, as shown in FIG. 20, a connecting device 150, which includes an identification signal adding means (not shown) generating and adding the identification number, may be intervened between the second pointing device 120 and the second pointing device connecting portion 132.

As described above, when the processor 133 of the computer body 130 makes the input signal, into which the identification number is added while passing though the connecting device 150, processed through the second pointing device recognition module 220, operation of the second pointer 142 on the monitor can be controlled independently from that of the first pointer 141.

This connecting device 150 may be connected in one-to-one to one pointing device 120, and alternatively, the connecting device 150 may be connected to both of the first and second pointing devices 110 and 120.

For example, as shown in FIG. 21, the connecting device 150 may have first and second ports (not shown) connected to the first and second pointing devices 110 and 120, respectively, and a third port (not shown) connected to the pointing device connecting portion 131 of the computer body 130.

In the connecting device 150, for example, an identification adding means (not shown), which adds a predetermined identification signal into an signal input through the second port, may be embedded. The connecting device 150 may alternately transmits signals input from the first pointing device 110 and the second pointing device 120 a method such as a time division method, and the computer body 130 recognizes the signal, into which the identification number is added, as a signal of the second pointing device 120.

A second method is a method that the processor 133 separately recognizes the first and second pointing device connecting portions 131 and 132 and signals input through the first and second pointing device connecting portions 131 and 132 are processes in the first and second pointing device recognition modules 210 and 220, respectively.

This method may be realized by connecting the first and second pointing device connecting portions 131 and 132 to the processor 133 through separate lines.

A third method is a method that the first and second pointing devices 110 and 120 are distinguished according to order in which the first and second pointing devices 110 and 120 are connected to the computer body 130 when one recognition module exists.

For example, a device, which is recognized in a process of booting the computer, may be considered as the first pointing device 110, and other device, which is later connected and recognized, may be considered as the second pointing device 120. When the two devices are connected at the same time, the processor 133 arbitrarily selects and designates the first and second pointing devices 110 and 120.

The recognition module performing this distinguishment may be located in any of the operation system, execution program and connecting device.

As described above, the two pointing devices 110 and 120 are connected to the computer body 130 and operated independently, and thus when a role play or story telling is performed on the computer, the activated effect can be given more.

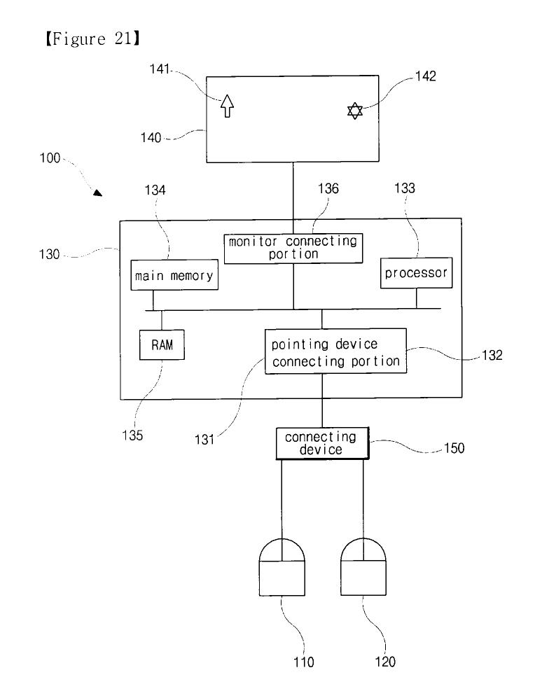

For example, as shown in FIG. 22, a teacher or parent takes the first and second pointing devices 110 and 120 in both hands, respectively, and a first object (dinosaur) is selected and operated using the first pointer 141 and a second object (person) is selected and operated using the second pointer 142. Accordingly, effect of the story telling or play can be maximized.

These multi pointers can be also used usefully for an interactive or two-way game.

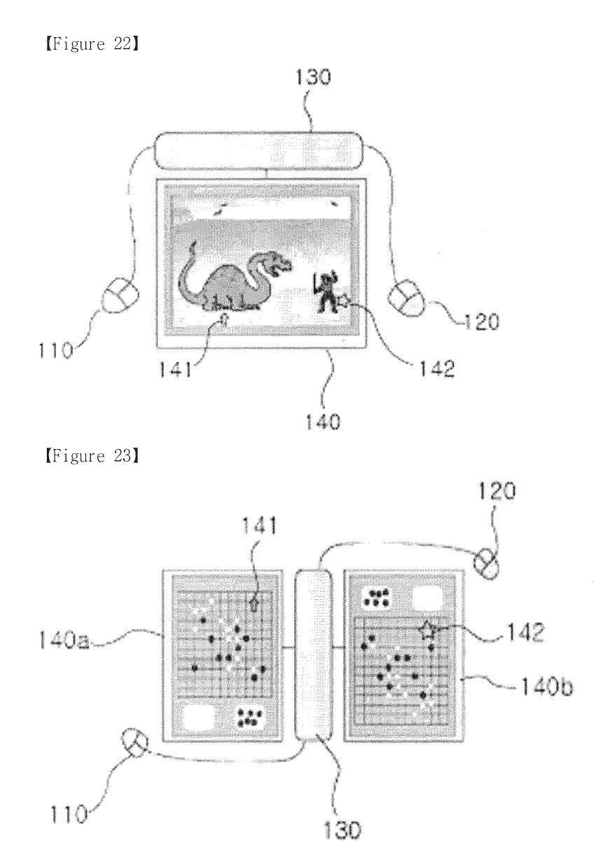

FIG. 23 shows a computer system where two pointing devices 110 and 120 and two monitors 140a and 140b are connected to one computer body 130 and two users uses the two monitors, respectively.

The first and second pointers 141 and 142 may be displayed on each of the monitors 140a and 140b, and in some cases, to prevent confusion of the user, the first pointer 141 may be displayed on the first monitor 140a and the second pointer 142 may be displayed on the second monitor 140b.

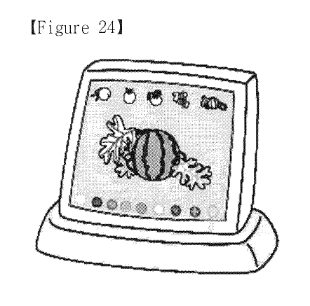

In the mean time, a pointing device such as a mouse is not used, and a touchscreen-type user interface may be provided, as shown in FIG. 24. In other words, a plurality of objects displayed on the monitor 140 is selected or moved not by a pointing device but according to moving of user's hand contacting the touchscreen.

For example, in FIG. 24, when the user selects an icon having a water melon shape at a top and right portion of a screen, a water melon image is displayed in a middle portion of the screen, and then, when a color icon is touched and then a certain portion of the water melon image, the certain portion of the water melon image is changed to have the selected color.

Even though this touchscreen type is difficult to apply to a complicated game, the touchscreen type can apply to a computer for playing or education for a child.

Further, when the multi pointers is used, two or three-dimensional graphic work can be realized more easily on the computer. For example, in a state that the pointing devices 110 and 120 are taken in both of left and right hands, respectively, a center axis of an image to draw is determined and a point is taken with the pointing device 110 and other point is taken with the other pointing device 120, and then various changes such as pulling, pushing and rotating can be given.

Further, when the pointing device 110 is used for work such as selecting of icon or menu and the other pointing device 120 is used for graphic work, moving distance of the pointers can be reduced. Accordingly, work efficiency can be improved and stress applied to a body due to work can be reduced.

In the mean time, the presentation program according to the embodiment of the present invention is not limited for the presentation performed on a notebook or desktop computer, and the presentation program may be installed in IPTV, a small-sized computer for a child and the like and used for education.

Further, the presentation program may be used through an internet. For example, a basic program may be downloaded and set up at a terminal of a subscriber, and a background image or object required to display images may be used through streaming or downloading from a service server.

Further, the animation effect or the function and arrangement of the keypad is not limited to the extent as described above.

1. A method of story telling presentation using a computer, the method comprising:
embedding multimedia objects including a plurality of images relevant to a specific story, a subject forming a story or a specific subject into an execution file, a system or a server using an usual computer and dumping the multimedia objects on a screen of the computer; and
selecting one of the dumped objects and arranging the one of the dumped objects at a certain position on a canvas or stage of a middle portion of the screen or a background screen.

2. A method of story telling presentation using a computer, the method comprising:
making main contents of educational materials and a story book into background images and objects and embedding the background images and objects in an execution file, a system or a server, and dumping the background images and objects on a screen of the computer;
selecting one of the dumped images and inputting the one of the dumped images on a canvas or stage of a middle portion of the screen or as a background screen; and
selecting one of the dumped objects and arranging the one of the dumped objects at a certain position on the canvas, stage or background screen.

3. A method of story telling presentation using a computer, the method comprising:
dumping multimedia objects including images, which a user prepares, relevant to a specific story or subject on a screen of the computer; and
sliding one of a plurality of background images embedded in an execution file, system or server or prepared by the user and inputting the one of the plurality of background images on a canvas or stage of a middle portion of the screen or as a background screen; and
selecting one of the dumped objects and arranging the one of the dumped objects at a certain position on the canvas, stage of the middle portion of the screen or the background screen.

4. The method according to one of claims 1 to 3, wherein an icon of an object group including a plurality of object images and an icon of an background image group including a plurality of background images relevant to a specific subject each are at least one and are displayed on the screen of the computer, and
wherein when one of the icons of the object group or the background image group is selected, icons of all objects included in the selected object group or icons of all background images of the selected background image group are dumped on the screen, in dumping the objects or images on the screen of the computer.

5. The method according to claim 4, wherein the plurality of objects included in the object group or the plurality of background images included in the background image group are embedded in a program operated on the computer.

6. The method according to claim 4, wherein the plurality of objects included in the object group or the plurality of background images included in the background image group are provided from a separate storing means, which is capable of being attached to or detached from the computer, connected to the computer.

7. The method according to claim 4, the plurality of objects included in the object group or the plurality of background images included in the background image group are provided through a streaming or downloading from a service server connected to the computer via an internet network.

8. The method according to one of claims 1 to 3, wherein the background image is input in a size of the canvas or stage occupying the middle portion of the screen, in inputting as the background screen.

9. The method according to one of claims 1 to 3, wherein selecting the one of the dumped objects and arranging the one of the dumped objects on the background screen includes:
determining a reference point in the canvas or stage using a pointer operated in the program;
moving the pointer in a desired direction and by a desired length and determining an end point; and
displaying the selected object in a square having the reference point and the end point as apexes facing each other,
wherein position, size and direction of the object are determined at once.

10. The method according to claim 9, wherein the pointer is operated by a mouse connected to the computer, and wherein a point where a button of the mouse is pressed is determined as the reference point and a point where the button of the mouse is unpressed is determined as the end point.

11. The method according to claim 9, wherein a sound representing the object is output when the object is selected using the pointer after displaying the selected object in the square.

12. The method according to claim 9, further comprising changing a brightness, color, size, ratio or direction of the object or moving the object after displaying the selected object in the square.

13. The method according to one of claims 1 to 3, further comprising a step of generating a special effect of a brightness change, color change, rain, snow, sun, cloud, wind, lightening or thunder on the background screen after selecting the one of the dumped objects and arranging the one of the objects on the background screen.

14. The method according to claim 13, wherein generating the special effect is performed in an one-touch method using a select button provided on the screen.

15. The method according to claim 13, wherein generating the special effect is performed in an one-touch method using a select button set in an input device connected to the computer.

16. The method according to claim 13, wherein generating the special effect is performed in a method to set a transparent layer on the background image and object and display an image or animation for the special effect of the brightness change, color change, rain, snow, sun, cloud, wind, lightening or thunder on the transparent layer.

17. The method according to one of claims 1 to 3, wherein when a folder search button on the screen of the computer is selected, a plurality of object group icons or a plurality of background image group icons are displayed, and when one of the object group icons or one of the background image group icons is selected, icons of all objects included in the selected object group or icons of all background images included in the selected background image group are dumped on the screen, in dumping the multimedia objects or images on the screen of the computer.

18. The method according to one of claims 1 to 3, wherein a special effect of a different animation method and effect sound is given to each object after selecting the one of the dumped objects and arranging the one of the dumped objects on the background screen.

19. A method of story telling presentation using a computer, the method comprising:
displaying an object on a screen of a computer;
moving the object on the screen; and
displaying a changed image of the object when a moving distance of the object satisfies a predetermined condition.

20. The method according to claim 19, further comprising capturing all images displayed on the screen according to a predetermined number of frames per second and saving the images as one animation file after displaying the changed image of the object.

21. A method of story telling presentation using a computer, the method comprising:
displaying an object on a screen of a computer;
moving the object on the screen; and
displaying a changed image of the object according to a moving direction of the object.

22. The method according to claim 21, wherein different four images are displayed according to four moving directions divided each having a range of 90 degrees angle with respect to a center point of the object.

23. A method of story telling presentation using a computer, the method comprising:
displaying an image of an object normally when the object is moved in a positive (+) x direction with respect to a reference point of the object, and displaying the image of the object left-side-right when the object is moved in a negative (−) x direction, in a case that the object displayed on a screen of a computer is moved.

24. A method of story telling presentation using a computer, the method comprising:
displaying an image of an object normally when the object is moved in a positive (+) y direction with respect to a reference point of the object, and displaying the image of the object up-side-down when the object is moved in a negative (−) y direction, in a case that the object displayed on a screen of a computer is moved.

25. A method of story telling presentation using a computer, the method comprising:
changing a color or brightness of a background image or object displayed on a screen of a computer by selecting one of “R”, “G”, “B” and “C” buttons along with a “+” or “−” button using a computer input device including the “R”, “G”, “B” buttons corresponding to red, green and blue, respectively, the “C” button to adjust the brightness, and the “+” and buttons.

26. A method of story telling presentation using a computer, the method comprising:
changing a size or ratio of a object displayed on a screen of a computer by selecting one of “↑”, “↓”, “→”, “←” and “0” (Original) buttons along with a “+” or “−” button using a computer input device including the “+”, “−”, “↑”, “↓”, “→”, “←” and “0” buttons, wherein the size or ratio of the object is changed with a directional property corresponding to the “↑”, “↓”, “→”, “←” or “0” button.

27. A method of story telling presentation using a computer, the method comprising:
displaying an object on a screen of a computer;
placing a pointer, which is operated on the screen by a pointing device connected to the computer, on the object and operating the pointing device;
disappearing the pointer and designating the object when the pointing device is operated; and
removing the designation of the object and appearing the pointer again when the pointing device is operated again.

28. The method according to one of claims 1 to 3 and 19 to 27, wherein the object is a two or three-dimensional image, animation or text.

29. A method of manufacturing a presentation multimedia file, wherein one multimedia file is manufactured by saving contents of the presentation performed on the canvas or stage by the method according to one of claims 1 to 3 and 19 to 27 in time sequence, and wherein the multimedia file includes informations of the background image and reference position, size and movement of the object displayed on the screen.

30. A method of story telling presentation using a computer, wherein the presentation is performed while the multimedia file manufactured by the method according to claim 29 is slided according to sequence of the presentation.

31. A method of manufacturing an image file, wherein images including all objects arranged on the canvas or stage by the method according to one of claims 1 to 3 and 19 to 27 are saved as one image file.

32. A method of story telling presentation using a computer, wherein the presentation is performed while the plurality of image files manufactured by the method according to claim 31 are slided according to sequence in a program.

33. A method of manufacturing an animation file, wherein images including all objects arranged on the canvas or stage by the method according to one of claims 1 to 3 and 19 to 27 are captured according to a predetermined number of frames per second and saved as one animation file.

34. A computer input device as an input device connected to a computer, the input device comprising:
an object change button group to adjust a size or width-length ratio of an object displayed on a screen of the computer;
an object move button group to move a position of the object or give an animation effect to the object;
an object rotate button group to rotate the object;
a color change button group to change a color of the screen or object; and
a sound effect button group to adjust intensity of a sound or to repeat the sound.

35. The input device according to claim 34, further comprising:
a special effect button group to give a special effect to the presentation screen; and
a screen change button group to change the presentation screen or adjust a size of the presentation screen.

36. The input device according to claim 34, wherein a part of the button groups of the input device is set using number keys, and the input device includes a switching means to selectively activate the number keys.

37. The input device according to claim 34, wherein the input device is a touchscreen.

38. A computer system, comprising:
a computer body in which operating system and application program are installed;
a display device connected to the computer body;
first and second pointing devices connected to the computer body and each generating a coordinate signal and an event signal to independently operate first and second pointers, respectively, displayed on the display device; and
an identification signal adding means generating an identification signal to distinguish signals of the first and second pointing devices and adding the identification signal into the signal of the first or second pointing device.

39. The computer system according to claim 38, wherein the identification signal has a predetermined bit pattern.

40. The computer system according to claim 38, wherein the identification signal adding means is installed in one of the first and second pointing devices.

41. The computer system according to claim 38, wherein at least one of the first and second pointing devices is connected to the computer body via a connecting device, and the identification signal adding means is installed in the connecting device.

42. The computer system according to claim 41, wherein the connecting device includes two pointing device ports to be connected to the first and second pointing devices, respectively, and one computer body port.

43. The computer system according to claim 38, wherein the display device includes two monitors connected to the computer body, two screens of the two monitors are set to face in opposite directions, and a number of the pointing devices is two.

44. A connecting device for a pointing device, the connecting device intervened between the pointing device and a computer body, the connecting device comprising:
a computer port connected to the computer body;
a pointing device port connected to the pointing device; and
an identification signal adding means to generate an identification signal to distinguish the pointing device with other pointing device and add the identification signal into a signal input from the pointing device.

45. A method of story telling presentation using a computer connected to a plurality of pointing devices, the method comprising:
displaying a plurality of pointers corresponding to the plurality of pointing devices, respectively, on one computer screen; and
independently selecting or moving an object displayed on the computer screen by each pointer controlled by an input signal from each pointing device.

46. A method of story telling presentation using a computer, the method comprising:
connecting a computer, which is connected to a first pointing device, to a second pointing device;
adding an identification signal into an input signal of the second pointing device and activating the second pointing device by a pointing device recognition module;
transmitting the input signal of the second pointing device by the pointing device recognition module; and
moving a second pointer and performing an event independently from the first pointing device.

47. A recognition module processing a signal of a second pointing device, which is connected to a computer connected to a first pointing device, wherein the module adds an identification signal into the second pointing device, activates the second pointing device and operates a second pointer using a generated signal.
